(19) United States
(12) Patent Application Publication
(10) Pub. No.: US 2023/0370564 A1
(43) Pub. Date: Nov. 16, 2023

(54) Television Detachable Sliding Charging Screens

(71) Applicant: Gregory Andrew Sales, Elizabeth, NJ (US)

(72) Inventor: Gregory Andrew Sales, Elizabeth, NJ (US)

(21) Appl. No.: 17/744,775

(22) Filed: May 16, 2022

(51) Int. Cl. H04N 5/63; H04N 5/64

(52) U.S. Cl. CPC H04N 5/63; H04N 5/64

(57) ABSTRACT

The purpose of this invention is an embodied sliding screen that is stored into a television front frame on a built in sliding frame. The built in sliding frame is embodied to allow you to store and access additional television screens. The built in television frame itself will store additional frames that move in and out of the television frame for other viewers to watch selected programs. This will allow one television to be used with detachable sliding screens. The built in additional televisions screens are connected to television tuner once sliding screens are disconnected. The sliding screen still connected to main television set will allow you to go anywhere, view any television programming coming from the television tuner. The detachable screens are charged by built in charger connected to television frame. This method works for all electronics with screens such as phones, camera's computers any screens possible same method.

### FIELD

The present application relates to a television and all electronic screen devices including cell phone screens, computer screens, watches screens, hand held electronic small screens, register screens and televisions screens any electronic screen possible.

### BACKGROUND

Screens of all electronic devices such as televisions, computers, registers, cell phones, stereo screens and any electronic screen possible. These screens are to interpret as many users as possible for individual use. These sliding screens are designed to be detached from original devices for mobile usage when you don't want to take devices with you. The chargeable sliding screen has a charging unit in each device that will allow you to charge sliding screen for usage. These sliding screens will allow a household of many to use the same television set or computer or any device with a screen by detaching a sliding screen from the device itself. This television sliding screen allows many members of a family to take a screen from the television set for their own personal use from the original television set. All screens of electronic designed devices will have a detachable unit for mobile usage on the go. You can detach screens from all devices and take with you once they are charged from original electronic device.

### SUMMARY

By providing a chargeable sliding electronic frame to store an electronic screen will allow the screen to be detached from the original television screen for second usage of other persons who want to watch a different program.

In one embodiment the chargeable sliding electronic screen is stored in the television frame that connects to a television charging unit that is used to charge the detachable screens.

In another embodiment the detachable screens connects to the original tuner of the television set that will allow you to access all programming from the original television set.

The embodiment of digital connection will allow the detachable screen to be used many miles away from the original television set of original connecting frame. You can detach screen from original television set and use it as a mobile connecting unit from original television set.

In an embodiment the original television frame holds several slots for several detachable screens to detach allowing many individuals to detach screens for their own television watching.

For future development of sliding screens, this method of concentration will be used to develop other electronic sliding screens such as cell phone detachable screens, register detachable screens, stereo detachable screens and computer detachable screens. This method of detachable screens justify all electronic screens ever made for any objects. This also constitutes remote glass sliding screens that will detach from screen units that will allow you to control things remotely.

### BRIEF DESCRIPTION OF DRAWING

FIG. 1A. Illustration of embodied television screen best described as a feature for a space of sliding screens to navigate back and forward in and out of the original frame of the television set itself.

FIG. 1B. Illustration of embodied detachable screen from a television unit built to navigate inward and outward of space built within original television set. Detachable screen designed within the original television set for second usage to viewers.

FIG. 1C. Illustration of embodied built in charging unit frame designed to charge detachable screens once stored in frame of the television which connects to detachable sliding screen. The charging frame slot charges the detachable screen itself.

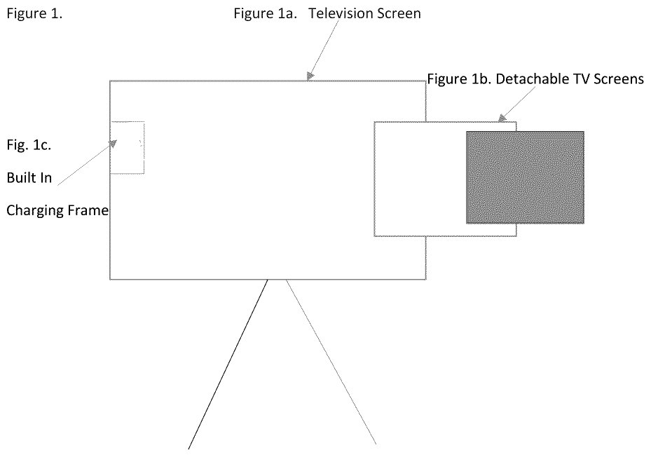

1. I claim the sliding storage frame built into the television frame to allow sliding screens to move back and forth for storage and charging connection.

2. I claim charging frame built inside of television used to charge detachable screens that are charged in the charging station built within the television.

3. I claim the tuner connection between the original television set and the detachable screens that will allow the detachable screen to operate and access television programming from original television set once detachable screens are detached from television set.
